(19) United States
(12) Patent Application Publication
(10) Pub. No.: US 2009/0061987 A1
(43) Pub. Date: Mar. 5, 2009

(54) THERMAL MANAGEMENT IN A WAGERING GAME MACHINE

(75) Inventors: Stephen A. Canterbury, Antioch, IL (US); Victor Mercado, Berwyn, IL (US); Craig J. Sylla, Round Lake, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS GAMING INC, WAUKEGAN, IL (US)

(21) Appl. No.: 12/282,817

(22) PCT Filed: Mar. 13, 2007
(86) PCT No.: PCT/US07/06296

§ 371 Date: Sep. 12, 2008

Related U.S. Application Data
(60) Provisional application No. 60/743,476, filed on Mar. 14, 2006.

(51) Int. Cl. A63F 13/00; A63F 9/24; G06F 19/00

(52) U.S. Cl. 463/20; 463/16; 463/43

(57) ABSTRACT

A computerized wagering game system includes a gaming module operable to conduct a wagering game on which monetary value can be wagered, and a thermal management module operable to monitor the temperature of one or more integrated circuits comprising a part of the wagering game machine. In one embodiment, the thermal management module monitors one or more temperature indicator signals provided by the integrated circuit, and the wagering game system is operable to change function in response to the temperature signals.

### RELATED APPLICATIONS

This patent application claims the priority benefit of U.S. Provisional Patent Application Ser. No. 60/743,476 filed Mar. 14, 2006 and entitled “INTEGRATED CIRCUIT THERMAL MANAGEMENT IN A WAGERING GAME MACHINE”, which application is incorporated herein by reference.

### FIELD OF THE INVENTION

The invention relates generally to computerized wagering game systems, and more specifically to integrated circuit thermal management in a wagering game machine.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, 2007, WMS Gaming, Inc.

### BACKGROUND

Computerized wagering games have largely replaced traditional mechanical wagering game machines such as slot machines, and are rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

The elements of computerized wagering game systems are in many ways the same as the elements in the mechanical and table game counterparts in that they must be fair, they must provide sufficient feedback to the game player to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games do not rely on the dealer or other game players to facilitate game play and to provide an entertaining game playing environment, but rely upon the presentation of the game and environment generated by the wagering game machine itself. Incorporation of audio and video features into wagering games to present the wagering game, to provide help, and to enhance the environment presented are therefore important elements in the attractiveness and commercial success of a computerized wagering game system. Music and environmental effects are also played through speakers in some wagering game systems to enhance or complement a theme of the wagering game. These sounds typically accompany video presentation of the wagering game on a screen, which itself often includes animation, video, and three-dimensional graphics as part of presentation of the wagering game.

All of these wagering game functions are typically managed by a processor executing wagering game code, which places a significant demand on the processor and related components. Modern processors can dissipate as much power as a 100-watt light bulb, and can quickly be destroyed if the generated heat is not controlled. Various combinations of heat sinks, fans, and even forced liquid cooling are often used to keep the processor cool, and their proper installation and operation are important to ensure proper operation of a computerized wagering game machine.

### SUMMARY

One example embodiment of the invention comprises a computerized wagering game system that includes a gaming module operable to conduct a wagering game on which monetary value can be wagered, and a thermal management module operable to monitor the temperature of one or more integrated circuits comprising a part of the wagering game machine. In a further embodiment, the thermal management module monitors one or more temperature indicator signals provided by the integrated circuit, and the wagering game system is operable to change function in response to the temperature signals.

### BRIEF DESCRIPTION OF THE FIGURES

FIG. 1 shows a computerized wagering game machine, as may be used to practice some embodiments of the invention.

FIG. 2 is a block diagram of a computerized wagering game machine as may be used to practice some embodiments of the invention.

FIG. 3 shows a block diagram of a wagering game machine integrated circuit assembly comprising thermal management, consistent with an example embodiment of the invention.

FIG. 4 is a flowchart illustrating a method of operating a wagering game machine including thermal management-based actions, consistent with an example embodiment of the invention.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

One example embodiment of the invention seeks to manage the thermal state of one or more integrated circuits in a wagering game system by use of a thermal management module. The computerized wagering game system includes a gaming module operable to conduct a wagering game on which monetary value can be wagered, and a thermal management module operable to monitor the temperature of one or more integrated circuits comprising a part of the wagering game machine. In a further embodiment, the thermal management module monitors one or more temperature indicator signals provided by the integrated circuit, and the wagering game system is operable to change function in response to the temperature signals.

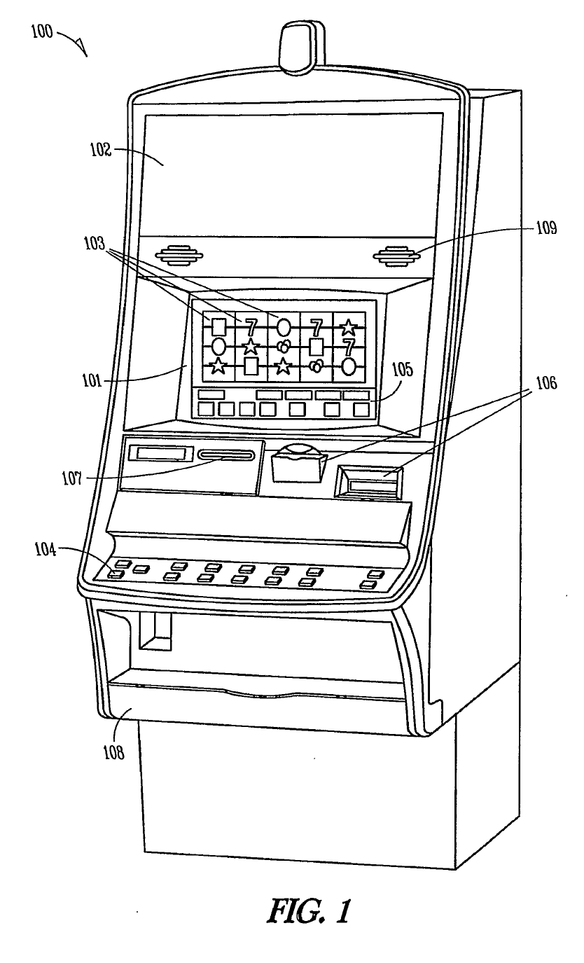

FIG. 1 illustrates a computerized wagering game machine, as may be used to practice some embodiments of the present invention. The computerized gaming system shown generally at 100 is a video wagering game system, which displays information for at least one wagering game upon which monetary value can be wagered on video display 101. Video display 101 is in various embodiments a CRT display, a plasma display, an LCD display, a surface conducting electron emitter display, or any other type of display suitable for displaying electronically provided display information. In some further embodiments, additional displays such as a bonus game display or top box display 102 are further operable to display electronically provided information to a wagering game player. Alternate embodiments of the invention will have other game indicators, such as mechanical reels instead of the video graphics reels shown at 103 that comprise a part of a video slot machine wagering game.

A wagering game is implemented using software within the wagering game, such as through instructions stored on a machine-readable medium such as a hard disk drive or nonvolatile memory. In some further example embodiments, some or all of the software stored in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered. The wagering game implemented via the loaded software takes various forms in different wagering game machines, including such well-known wagering games as reel slots, video poker, blackjack, craps, roulette, or hold 'em games. In some further embodiments, a secondary game or bonus game is displayed on the secondary display 102, or other information such as progressive slot information or other community game information is displayed.

The wagering game is played and controlled with inputs such as various buttons 104 or via a touchscreen overlay to video screen 101. The touchscreen is used in some embodiments to display virtual buttons, which can have unique functions in some embodiments, or can duplicate the functions provided by the mechanical buttons 104 in other embodiments. In some alternate examples, other devices such as virtual buttons 105 on the touchscreen display or a pull arm are employed to provide other input interfaces to the game player, such as to initiate reel spin. The player interface components are in this example contained within or mechanically coupled to the wagering game system, but in other embodiments will be located outside the wagering game system cabinet such as by a wired or wireless electronic connection to the wagering game system.

Monetary value is typically wagered on the outcome of the games, such as with tokens, coins, bills, or cards that hold monetary value. The wagered value is conveyed to the machine such as through a changer 106 or a secure user identification module interface 107, and winnings are returned such as via a returned value ticket, a stored value card, or through the coin tray 108. Sound is also provided through speakers 109, typically including audio indicators of game play, such as reel spins, credit bang-ups, and environmental or other sound effects or music to provide entertainment consistent with a theme of the computerized wagering game. In some further embodiments, the wagering game machine is coupled to a network, and is operable to use its network connection to receive wagering game data, track players and monetary value associated with a player, and to perform other such functions.

In other embodiments, the computerized wagering game system takes one or more other forms, such as a mobile or portable wagering game device, a server-based wagering game device, or a networked wagering game system. These other computerized wagering game system embodiments need not contain all features of the wagering game system of FIG. 1, which does not limit the scope of a computerized wagering game but is provided as an example only.

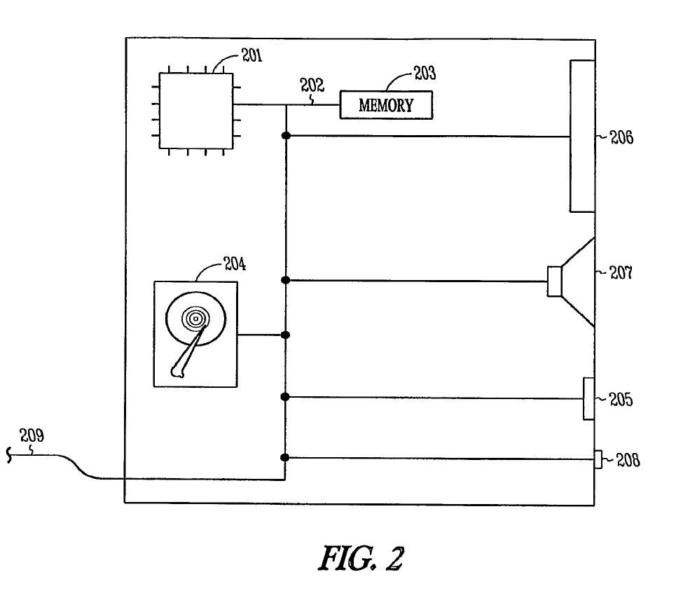

FIG. 2 shows a block diagram of an example embodiment of a wagering game system. The wagering game system includes a processor 201, which is sometimes called a microprocessor, controller, or central processing unit (CPU). In some embodiments, more than one processor is present, or different types of processors are present in the wagering game system, such as using multiple processors to run gaming code, or using dedicated processors for audio, graphics, security, or other functions. The processor is coupled via a bus 202 to various other components, including memory 203 and nonvolatile storage 204. The nonvolatile storage is able to retain the data stored therein when power is removed, and in various embodiments takes the form of a hard disk drive, nonvolatile random access memory such as a compact flash card, or network-coupled storage. Further embodiments include additional data storage technologies, such as compact disc, DVD, or HD-DVD storage in the wagering game system.

The bus 202 also couples the processor and components to various other components, such as a value acceptor 205, which is in some embodiments a token acceptor, a card reader, or a biometric or wireless player identification reader. A touchscreen display 206 and speakers 207 serve to provide an interface between the wagering game system and a wagering game player, as do various other components such as buttons 208, pullarms, and joysticks. These components are located in a wagering game machine cabinet such as that of FIG. 1 in some embodiments, but can be located in multiple enclosures comprising a wagering game system or outside a wagering game machine cabinet in other embodiments.

In operation, the wagering game system loads program code from nonvolatile storage 204 into memory 203, and the processor 201 executes the program code to cause the wagering game system to perform desired functions such as to present a wagering game upon which monetary value can be wagered. This and other functions are provided by various modules in the computerized system such as an audio module, a game presentation module, or a touchscreen display module, where such modules comprise in some embodiments hardware, software, mechanical elements, manual intervention, and various combinations thereof.

The software instructions executing on the computer, hardware features of integrated circuits such as the processor, and various other combinations of hardware and software are used in some embodiments to monitor and react to temperature conditions in one or more integrated circuits within the wagering game machine, such as processor 201. In one such embodiment, the processor includes a thermal sensor such as a diode, which is formed on the integrated circuit along with other circuits. A small current is driven through the forward-biased diode, and an analog-to-digital converter reads the forward bias voltage generated by the applied current signal and stores the result in a register. This value is then converted to a temperature by means of a lookup table, either in the processor or using external methods such as software or an external hardware conversion table.

More complex examples include use of multiple thermal signals from the processor or from a thermal management module including a temperature sensor sufficiently near the integrated circuit to monitor its temperature. In one such example, the thermal signals include a temperature indicator signal, a thermal level-triggered power reduction notification signal indicating that the power state of the processor is being reduced due to the temperature exceeding a threshold, and a critical temperature-triggered integrated circuit shutdown signal from the temperature sensing system indicating that integrated circuit operation will be halted to prevent hardware damage to the processor.

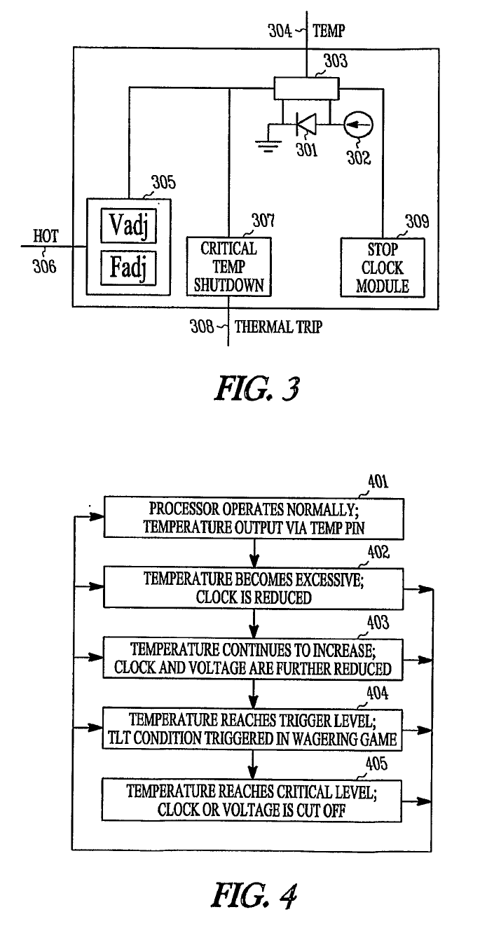

FIG. 3 is a block diagram illustrating an example of such a temperature reporting system, including a processor having multiple thermal reporting signals. In some embodiments, the various signals provided by the processor are received in a chipset or stored in a register such that they can be monitored by software processes, while in other embodiments one or more of the signals generates a hardware interrupt.

In this example, a thermal diode 301 is forward biased and driven by a current source 302, and the voltage across the diode is measured by an analog-to-digital converter 303. A lookup table or other method is used to convert the measured voltage to a temperature of the diode junction, and is output as a temperature signal 304. In some embodiments, the components 301-304 are a part of the integrated circuit being monitored, while in other embodiments various components of the thermal monitoring system are external to the integrated circuit, such as within an integrated circuit socket or heat sink assembly. In various embodiments, the temperature signal is used to control cooling fans or other devices, and is used by other hardware or software for functions such as to control the clock speed or power level of the processor.

In a further embodiment, an integrated circuit thermal management module 305 uses sensed temperature information such as from the thermal diode 301 to regulate the voltage and the clock frequency provided to the integrated circuit when the temperature reaches excessive levels. In one embodiment, the clock is stopped periodically to reduce the power dissipated in the integrated circuit, while other embodiments include reducing the clock frequency supplied to at least some of the digital logic circuits in the integrated circuit. Similarly, the operating voltage can be reduced to reduce the power dissipated in some embodiments. Because the minimum voltage needed to operate the integrated circuit may increase as clock speed increases, additional benefit is realized in some embodiments by controlling or reducing both the clock speed and voltage simultaneously.

An output signal 306 is provided to indicate that the integrated circuit thermal management module 305 has detected an excessive temperature, which can be used for external control of hardware or software such as to generate a tilt condition or report a potential cooling problem to service technicians.

In another embodiment, a critical temperature shutdown controller 307 is coupled to receive a thermal state signal such as from the thermal diode 301, and is operable to completely shut down the integrated circuit to prevent hardware damage should a critical temperature be reached. Such a condition may occur when a cooling system fails, such as when a cooling fan stops working, when a heat sink becomes detached, or when a cooling duct or vent is blocked. In further embodiments, a thermal trip signal is output from the critical temperature shutdown module to indicate the reason for the shutdown condition.

Shutting down can comprise disconnecting voltage to one or more portions of the integrated circuit, or stopping the clock such as via a stop clock module 309 for at least some circuits within the integrated circuit.

FIG. 4 shows a flowchart of a method of operating a wagering game system such as that of FIGS. 1 and 2, and having thermal management features such as those shown in FIG. 3. At 401, the wagering game system is operating normally, and a processor integrated circuit is providing its temperature to external devices via a temperature output signal such as through temp pin 304 of the integrated circuit. As greater demands are placed on the processor, or as various cooling components associated with the processor become less effective or fail, the temperature reaches an excessive level outside the normal operating temperature range at 402. The clock speed is then reduced using a thermal management module such as 305 of FIG. 3, and a hot condition signal is provided to external components such as through hot signal connector 306.

In some embodiments, this is sufficient to signal improper operation of the wagering game system and to generate a tilt condition. In other embodiments, such a hot condition must be sustained for a period of time, such as several minutes, to generate a tilt condition, or the temperature must reach some further elevated state to cause a tilt. In embodiments where a tilt condition is not realized until relatively high temperatures are detected, other measures can be taken based on earlier temperature warnings, such as increasing fan speed or other cooling mechanism operation, or providing a warning through a data log, a networked alert message, or other such warning.

As the temperature continues to rise, the clock signal is either reduced in frequency or modulated, and the voltage is reduced at 403. In embodiments where the clock signal frequency is reduced, a normal operating frequency such as 2 GHz is reduced to a lower frequency such as 500 MHz to reduce the number of state transitions and power consumed in the processor. In some embodiments, a large number of reduced operating frequencies may be available for use depending on the detected processor temperature. When the clock is modulated, the clock may continue to operate at normal speed or at a reduced speed, but does not operate continuously. For example, a 2 GHz clock may continue to operate at 2 GHz, but may alternate between running for 50 ms and being off for 50 ms.

Voltage typically can't be reduced significantly unless clock speed is also reduced, so voltage and clock speed are reduced together in some further embodiments. Extending the example 2 GHz processor reduced to 500 MHz due to excessive temperature, the operating voltage may also be reduced from a normal operating voltage such as 1.5 volts to a lower operating voltage of 1.2 volts. This further reduces the power dissipated in the processor's circuits as they change state with each clock cycle.

At 404, the temperature reaches a predetermined tilt condition level, and the wagering game machine stops presenting the wagering game and enters a tilt condition. This includes in some embodiments recording the wagering game state at the time of malfunction so that the credits accumulated, results of a game event in play, and other such information can be retrieved. In some embodiments, it also includes various alarms such as a network message, a flashing light, an audible alarm, or other indicator to attract the attention of gaming facility personnel.

Should the temperature reach a critical level at which the physical structure of the processor integrated circuit is at risk of being damaged, the clock or voltage signal provided to at least some of the circuits in the processor is cut off. Not all circuits need be cut off, such as where the processor's state, power management, and other processor-related data continue to be managed while the core functions of the processor are disabled. Such an event is likely to occur in cases where a processor cooling system fails, such as where a heat sink becomes loose or is not properly thermally coupled to the processor, where a cooling fan stops working, or where cooling vents or ducts used to supply cool air to the processor become clogged or blocked.

In many situations, the chain of thermal states will not proceed all the way from normal operation at 401 to shutdown at 405, but will stop and revert to some cooler mode of operation as indicated by the arrows in the flowchart. This can happen as a result of a lower demand being placed on the processor, or as a result of fixing whatever processor cooling conditions originally resulted in the elevated temperature state.

The examples presented here illustrate how some embodiments of an integrated circuit thermal management system can be used in a wagering game system to protect the continued integrity of the integrated circuit. Although specific embodiments have been illustrated and described herein, it will be appreciated by those of ordinary skill in the art that any arrangement that achieve the same purpose, structure, or function may be substituted for the specific embodiments shown. This application is intended to cover any adaptations or variations of the example embodiments of the invention described herein. It is intended that this invention be limited only by the claims, and the full scope of equivalents thereof.

1. A computerized wagering game machine, comprising:
a gaming module operable to present a wagering game on which monetary value can be wagered; and
a thermal management module operable to monitor the temperature of one or more integrated circuits comprising a part of the wagering game machine.

2. The computerized wagering game machine of claim 1, wherein the integrated circuit is a processor.

3. The computerized wagering game machine of claim 1, wherein the thermal management module comprises a thermal sensor that comprises a part of the integrated circuit.

4. The computerized wagering game machine of claim 1, wherein the thermal management module is further operable to generate a tilt condition in the wagering game machine if the monitored temperature exceeds a predetermined temperature.

5. The computerized wagering game machine of claim 4, wherein the tilt condition comprises at least one of suspending wagering game play, notifying a wagering game establishment of a malfunction, and recording the state of the wagering game to a nonvolatile memory at the time of the tilt.

6. The computerized wagering game machine of claim 1, wherein monitoring the temperature of one or more integrated circuits comprises receipt of one or more of a temperature signal, a thermal level-triggered power reduction notification, and a critical temperature-triggered integrated circuit shutdown signal from the one or more integrated circuits.

7. The computerized wagering game system of claim 1, wherein monitoring the temperature of one or more integrated circuits comprises monitoring the operation of one or more active cooling devices coupled to the one or more integrated circuits.

8. A method of operating a wagering game machine, comprising:
presenting a wagering game on which monetary value can be wagered; and
monitoring a temperature of one or more integrated circuits comprising a part of the wagering game machine.

9. The method of operating a wagering game machine of claim 8, wherein the integrated circuit is a processor.

10. The method of operating a wagering game machine of claim 8, wherein monitoring the temperature comprises monitoring a thermal sensor that comprises a part of the integrated circuit.

11. The method of operating a wagering game machine of claim 8, further comprising generating a tilt condition in the wagering game machine if the monitored temperature exceeds a predetermined temperature.

12. The method of operating a wagering game machine of claim 11, wherein the tilt condition comprises at least one of suspending wagering game play, notifying a wagering game establishment of a malfunction, and recording the state of the wagering game to a nonvolatile memory at the time of the tilt.

13. The method of operating a wagering game machine of claim 8, wherein monitoring a temperature of one or more integrated circuits comprises receipt of one or more of a temperature signal, a thermal level-triggered power reduction notification, and a critical temperature-triggered integrated circuit shutdown signal from the one or more integrated circuits.

14. The method of operating a wagering game machine of claim 8, wherein monitoring a temperature of one or more integrated circuits comprises monitoring the operation of one or more active cooling devices coupled to the one or more integrated circuits.

15. A machine-readable medium with instructions stored thereon, the instructions operable when executed to cause a computerized wagering game machine to:
present a wagering game on which monetary value can be wagered; and
monitor a temperature of one or more integrated circuits comprising a part of the wagering game machine.

16. The machine-readable medium of claim 15, the software when executed further operable to generate a tilt condition in the wagering game machine if the monitored temperature exceeds a predetermined temperature.

17. The machine-readable medium of claim 16, wherein the tilt condition comprises at least one of suspending wagering game play, notifying a wagering game establishment of a malfunction, and recording the state of the wagering game to a nonvolatile memory at the time of the tilt.

18. The machine-readable medium of claim 15, wherein monitoring a temperature of one or more integrated circuits comprises receipt of one or more of a temperature signal, a thermal level-triggered power reduction notification, and a critical temperature-triggered integrated circuit shutdown signal from the one or more integrated circuits.

19. The machine-readable medium of claim 15, wherein monitoring a temperature of one or more integrated circuits comprises monitoring the operation of one or more active cooling devices coupled to the one or more integrated circuits.

20. The machine-readable medium of claim 15, wherein the monitoring is performed by monitoring an output signal provided from the integrated circuit.
